(19) United States
(12) Patent Application Publication
(10) Pub. No.: US 2023/0310929 A1
(43) Pub. Date: Oct. 5, 2023

(54) TWO-PERSON EXERCISE WHEEL MECHANISM

(71) Applicant: Jiang SHU, Beijing (CN)

(72) Inventor: Jiang SHU, Beijing (CN)

(21) Appl. No.: 18/024,935

(22) PCT Filed: Dec. 14, 2020
(86) PCT No.: PCT/CN2020/000297

§ 371 Date: Mar. 6, 2023

(30) Foreign Application Priority Data
Sep. 7, 2020 (CN) 202010925762.8

(51) Int. Cl. A63B 22/20; A63G 29/00; G09B 9/10; A63B 22/06; A63B 69/00

(52) U.S. Cl. CPC A63B 22/20; A63G 29/00; G09B 9/10; A63B 22/0605; A63B 69/0057; A63B 2208/0233

(57) ABSTRACT

Embodiments of the present disclosure relate to a two-person exercise wheel. The two-person exercise wheel may include an exercise ring, a non-equilateral parallelogram linkage mechanism, a tension spring, and a suspension seat. When the ring is rotated, the non-equilateral parallelogram linkage mechanism may be rotated by a rocker arm. In some embodiments, the gravitational forces and the tension spring connected between the two seats act on the ring via the non-equilateral parallelogram linkage mechanism and the rocker arm. In some embodiments, the supporting force of the ring may pass through a circular center. Further, the gravitational forces may act on the non-equilateral parallelogram linkage mechanism and the persons on the seats may pedal to enable the ring to gain a rotation torque. Further, the tension spring may adjust the torque between the seats and the circular center when the two seats are in positions different from each other.

### TECHNICAL FIELD

The present invention is pertaining to the field of machinery and relates to a mechanical structure of a two-person exercise wheel. In particular, it relates to a mechanical wheel for two persons to use.

### BACKGROUND

The existing wheel for training air-force pilots is a simple ring with a position-fixed circular center, which is intended for one person to use. It uses manpower as a driving force and, due to high difficulty, ordinary people cannot handle it, therefore, it basically has no entertainment function.

### SUMMARY

The two-person exercise wheel according to the present invention is an innovative combined mechanical structure system, which uses manpower as the driving force in combination with gravitational force and ground support force to provide people an exercise machinery that is of a low difficulty of use, interaction-effective, and suitable for public entertainment and for two persons to play.

According to the present invention, on a rotatable ring, each of the two points at which a diameter line passing the circular center intersects the ring is hinged to a bottom end of one rocker arm lever, so that the top ends of two rocker arm levers can be in suspensible hingement respectively to opposite ends of a parallelogram linkage mechanism between which a tension spring is further linked, and the two ends of the parallelogram linkage mechanism that are not hinged to the rocker arm levers are provided, on articulated axles, with outward extending portions that can rest on external support beams. Since stoppers are mounted at positions near the bottom ends of the rocker arm levers, the rocker arm levers are restricted in terms of their rotation direction. When the ring is rotated, the rocker arm levers will push the parallelogram linkage mechanism forward since they cannot sink, so that the center of gravity formed by gravity acting on the parallelogram linkage mechanism of the ring will be positioned before the circular center of the ring in the rotation direction. The supporting force to the ring passes through the circular center, thereby forming a torque for forward rotation. The support beams function to appropriately provide upward supporting forces to lower sides of two load-free ends of the parallelogram linkage mechanism, to allow a load-bearing end outside the ring to stretch out distally, thereby obtaining a greater rotation torque to overcome rotational resistance. The tension spring between the two ends of the parallelogram linkage mechanism duly draws the two load-bearing ends of the parallelogram linkage mechanism closer, thereby overcoming the rotation difficulty due to the gravity when the two seats are in an upper and lower relationship. Therefore, these interaction forces can be in a mechanical system of repeated cycle conversion. This is the basic mechanical structure of one exercise wheel.

Two exercise wheels are fixedly connected in parallel, and with a concentric axis. Since the two exercise wheels have the same structure, they are symmetrical with each other at same positions, and in this way the connecting lines between the same positions on the two rings are all parallel to the concentric axis of the two rings. Because this is a wheel for two persons to use, it is necessary to have a seat hinged, with use of suspension racks, in a horizontal spacing between a hinge end of the parallelogram linkage mechanism of on one ring to which the spring is hinged and a hinge end of the parallelogram linkage mechanism of the other ring at a symmetrical position. The seat is formed by a combination of the suspension racks and a seat plate, the rocker arm levers have their ends hinged to the parallelogram linkage mechanism, and one seat is installed between the ends at the same positions. Therefore, the rings with two seats installed constitute a complete two-person exercise wheel.

When the two-person exercise wheel is rotated, the direction of the supporting force coming from the ground to the ring must pass through the circular center, so the purpose of arranging the non-equilateral parallelogram linkage mechanism is to allow the center of gravity of the non-equilateral parallelogram linkage mechanism mounted in a suspending manner to be positioned before the circular center in the rotation direction of the ring. Therefore, it should be ensured that when the two ends of the non-equilateral parallelogram linkage mechanism rotated to upper and lower positions, and the lower end is directly below the circular center, the upper end has been rotated to a position before the circular center of the ring. In this way, by virtue of gravitational force, the ring can continue to obtain a forward rotation torque and overcome the rotational resistance, furthermore, it is also ensured that the rocker arm lever in connection with the seat can effectively enter the stopper.

At each of the outward positions of the two sides of the exercise wheel mechanism, a ring is fixedly mounted, the two externally-connected rings that are in fixed connection are parallel to the rings of the exercise wheel mechanism, and have the function that the width between the two parallel externally-connected rings is wider, so it is less likely to topple when doing exercise, and the larger diameter can provide greater activity space for the rocker arm levers of the exercise wheel mechanism and the persons on the seats. The externally-connected rings can be called as outer ring, and the rings of the original exercise wheel can be called as inner ring.

The support beams of each exercise wheel are divided into unmovable and movable support beams, and the articulated axels of the suspension ends of the parallelogram linkage mechanism have outward extending portions directly resting on the support beams, thereby alternately providing support for the parallelogram linkage mechanism. The support beams are possible to provide support for the front-positioned suspension end when the two seats are in upper and lower positions, thereby reducing the strength requirements for the tension spring. When the seats are in front and rear positions, the lower suspension end of the parallelogram linkage mechanism can be pushed up, allowing the front seat to lean out, so that a greater rotation torque is obtained. The shapes of the support beams can be modified according to the motion trajectory of the articulated axles, so that they can reach the outward extending portions of the articulated axles. In this way, not only the support from the support beams can be obtained, but also there is no blockage during exercise.

One stopper is provided correspondingly at each of the two hinge points between the inner ring and the two rocker arm levers. Both the two stoppers are fixedly connected to the ring. Each of the stoppers can be provided with a one-way ratchet mechanism, for example. The function is that when the ring is rotated in a clockwise direction, the rocker arm levers are only allowed to rotate counterclockwise at the positions of the stoppers by taking the points at which the rocker arm levers are hinged to the ring as circular centers, but not to rotate clockwise. When the points at which the rocker arm levers are hinged to the ring move upward, the gravitational force acting on the ends at which the rocker arm levers are hinged to the parallelogram linkage mechanism restricts the activity of the rocker arm levers within the stoppers, and the rocker arm levers are restricted such that they ascend at the positions of the connecting lines pointing to the circular center as their hinge points to the ring rise. When the points at which the rocker arm levers are hinged to the ring move downward, the rocker arm levers are exactly in a release direction, that is, they can be rotated counterclockwise, and in this way the ends at which the rocker arm levers are hinged to the parallelogram linkage mechanism go beyond the ring, so that the ring can obtain a greater forward rotation torque.

Between the two ends of the parallelogram linkage mechanism, when the two seats are close to the horizontal position, the forwarding degree of the front seat relative to the torque to the circular center of the ring is adjusted in the rotation and forward direction of the ring, the torque of the rear seat to the circular center is short, the asymmetrical torque relationship is used to overcome the rotational resistance. The purpose of arranging the tension spring is such that the spring would be compressed when the two seats are close to the vertical position, to pull the two seats to close to the position of the circular center, so that the torque is shortened and the rotational resistance is reduced. The purpose of arranging a spring strength adjustment device is to lessen the difficulty in rotation of the ring caused by different loads on the two seats; moreover, since the two-person exercise wheel is composed of two exercise wheel mechanisms, the spring strength on both sides should be consistent.

The ring of the two-person exercise wheel can be directly supported by a connecting rod that is supported by the ground and passes through the circular center, thereby playing the function of the original ring, and the normal operation can be achieved in further cooperation with the support beams fixed to the ground.

The seat plate can be separated from the suspension racks, and connected by a flexible material in a suspending manner. The upper ends of the suspension racks of the seat are hinged to the articulated axles at the top ends of the rocker arm levers and in the same positions on the two parallel rings. One back beam of the seat is provided between the suspension racks on both sides of each seat. The suspension racks and the back beam are made of a rigid material, which can make the parallelogram linkage mechanisms hinged on both sides keep an unchanged distance therebetween during exercise. The seat plate can be either flexible or rigid. Since the seats are connected in a suspending manner, the persons on the seats can use the suspending effect by the gravitational force to find a balance point and maintain the seat plate in a natural balancing state upwardly. A fixed connection between the seat plate and the suspension racks is also possible.

A pedal is provided in the middle of the ring, and the pedal can be divided into two parts with the circular center being used as a boundary point, as long as a torque along a same direction as the rotation direction of the wheel can be formed between the position of the feet on the pedal and the circular center, the pedaling manner can be used to apply a forward rotation torque to the exercise wheel. When the two seats are in upper and lower positions, the difference between the torques of the gravitational forces acting on the two seats relative to the circular center is reduced to such an extent that no forward rotation torque can be provided to the wheel any longer, at this point, the person in the upper position can pedal the forward part of the pedal with his/her feet to provide a forward rotation torque to the wheel by virtue of his/her gravitational force.

The armrest handles on the seat are rigidly connected to the suspension racks of the seat, which can maintain the balance of the body at all times during exercise. The directions of the forces that the hands pull the armrest handles are designed to be oriented to the axel positions where the suspension racks are hinged to the parallelogram linkage mechanisms as far as possible. A safety belt can also be provided, similar to that on a car seat, which is wrapped around the waist and cooperates with the back beam of the seat to ensure the safety during exercise.

### BRIEF DESCRIPTION OF DRAWINGS

FIG. 1 is a schematic view of a basic structure of a two-person exercise wheel.

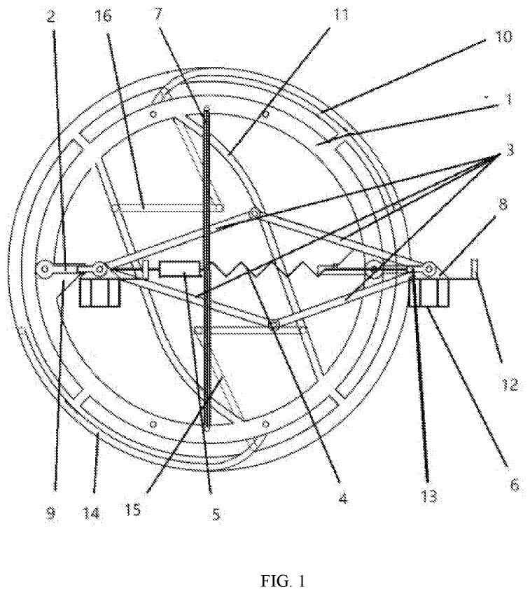

FIG. 2 is a sectional view of a specific structure of a two-person exercise wheel.

1—Ring; 2—Rocker arm lever; 3—Parallelogram linkage mechanism; 4—Tension spring; 5—Spring adjustment device; 6—Seat plate; 7—Pedal; 8—Suspension rack; 9—Stopper; 10—Outer ring; 11—Support beam; 12—Armrest handle; 13—Back beam; 14—Depression bar; 15—Carrier rod; 16—Movable support beam

### DESCRIPTION OF EMBODIMENTS

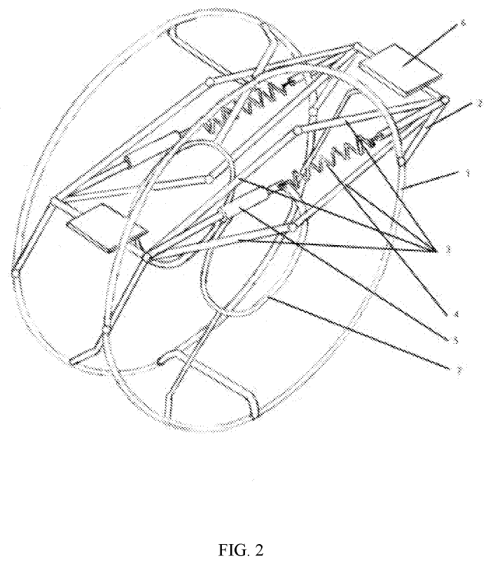

The following is a detailed description of operating principles and usage modes of a specific embodiment of the present invention in conjunction with a schematic view of a basic structure of a two-person exercise wheel as shown in FIG. 2.

A two-person exercise wheel is provided with two seat plates (6), on each of which there is a user. Two persons are subjected to pull by the earth gravity to form two downward gravitational forces at the positions of the two seat plates (6). During a rolling process, the two-person exercise wheel would always obtain an upward supporting force by virtue of a contact surface between a ring (10) and the ground, and this supporting force always passes through the circular center of each of rings (1), (10). When the two seat plates (6) are in a horizontal position, a depression bar (14) mounted on the outer ring (10) of the two-person exercise wheel is pressed into the outer ring (10), and the depression bar (14) pushes up a movable support beam (16) through an carrier rod (15). At this point, a lower suspension end of a non-equilateral parallelogram linkage mechanism (3) can be supported by the movable support beam (16). One end of the non-equilateral parallelogram linkage mechanism (3) having the gravitational force is behind the forward direction of the ring, and is supported upward by a rocker arm lever (2) on the ring (1), and is closer to the circular center; the gravitational force at the front end of the non-equilateral parallelogram linkage mechanism (3) is farther away from the circular center. The gravitational forces plus the restriction forces of rocker arm levers (2) connected to the ring (1) in combination with the support beam (16) make a spring (4) between the two ends of the non-equilateral parallelogram linkage mechanism (3) stretched to the maximum. With a varied difference between torques of the gravitational forces on the two seat plates (6) in relative to the circular center of the ring (1) in the horizontal position, the person in the front position can obtain a greater rotation torque in relative to the person in the rear position, so that the two-person exercise wheel is rotated toward a forward direction, and meanwhile the person in the rear position is pushed to a high position. As the person in the front position is rotated to a lower position, at an end of an articulated axle of the non-equilateral parallelogram linkage (3) to which no seat is hinged, an outward extending portion of the articulated axel rests on an unmovable support beam (11), functioning to support the non-equilateral parallelogram linkage mechanism (3). In this way, the gravitational force acting on the upper seat can suppress the non-equilateral parallelogram linkage mechanism. With the characteristics of the non-equilateral parallelogram linkage mechanism, the lower seat is pulled up, so that the difference between gravitational forces on the upper and lower seats (8) is affordable within the tensile strength of the spring (4) and that the two seats (8) are close in the upper and lower positions, thereby reducing the torque as required for overcoming a rotational resistance. Meanwhile, since connecting rods of the non-equilateral parallelogram linkage mechanism (3) hinged to the lower seat present a long right rod, the rocker arm levers can be effectively pushed into stoppers (9), playing their function of restricting the rocker arm levers (2) from moving clockwise. With the rotation, the front seat plate (6) and the rear seat plate (6) are gradually in relative up and down positions, and the advantage of the varied difference between torques will gradually decrease. At this point, the rotation energy mainly comes from the rotational inertia of the two-person exercise wheel obtained previously, moreover, the person on the upper seat plate (6) pedals a front part of a pedal (7) with his/her feet, and continues to use manpower to push the two-person exercise wheel to rotate forward. Since the parallelogram linkage mechanism (3) is designed as a non-equilateral parallelogram linkage mechanism (3), in the forward direction, at the end of the non-equilateral parallelogram linkage mechanism (3) hinged with the spring (4) in the front position, the two connecting rods are an upper long rod and a lower short rod, and at the end of the non-equilateral parallelogram linkage mechanism (3) hinged with the spring (4) in the rear position, the two connecting rods are a lower long rod and an upper short rod. Such a design is made relying on the structural characteristics of the non-equilateral parallelogram linkage mechanism (3), so that till the person who was originally in the front position is rotated to the position directly below the circular center, the center of gravity of the person in the upper position at this time has moved to a front position relative to the circular center of the ring (1) due to the effect of the long connecting rod, and the person in the lower position has a zero torque in the horizontal position relative to the circular center, and for the person in the upper position, his/her center of gravity has already been in a forward position in the horizontal position relative to the circular center. The gravitational force acting on the upper seat plate (6) causes the two-person exercise wheel to continue to obtain a forward rotation torque until the persons on the two seat plates (6) returns to horizontal positions. Cycle by cycle, the two-person exercise wheel keeps rotating. The tension spring (4) is also provided with an adjustment device (5), which aims to compensate for a difference between weights of the two persons on the exercise wheel and to maintain consistent strength on the left and right sides of the spring. Suspension racks (8) on both sides of each seat have their upper ends hinged to two ends of the non-equilateral parallelogram linkage mechanism (3) to which the spring (4) is hinged, and are in a suspending state, so that during the exercise, the suspended seat plate (6) can maintain a natural balance upwardly by virtue of its gravitational force. At the same time, a pedal (7) is provided between the two rings (1) arranged in parallel and also provided in the middle position to the inner rings (1), which aims to duly use feet to add force on the pedal (7) during rotation of the two-person exercise wheel, so that the rings are rotated forward. Armrest handles (12) rigidly connected to the suspension racks can give the person on the seat a gripper to maintain balance during the exercise. In cooperative arrangement, a safety belt is attached to the suspension racks of the seat where the suspension racks are connected to the articulated axels, and a back beam (13) of the seat is further fixedly connected to the suspension racks (8) on both sides of the seat, both of them point to the positions of the articulated axels. The safety belt is arranged in front of the person on the seat, which together with the back beam (13) of the seat forms a protective ring to ensure safety and fun during the exercise.

1.-10. (canceled)

11. A two-person exercise wheel mechanism, comprising:
a ring; a rocker arm lever; a parallelogram linkage mechanism; a spring; a stopper; and one or more support beams, wherein:
two rocker arm levers have their bottom ends respectively hinged to two points of the ring at which a diameter line intersects the ring;
the two rocker arm levers have their top ends hinged to opposite ends of the parallelogram linkage mechanism between which a tension spring is provided; and
two stoppers are positioned at the bottom ends of the two rocker arm levers.

12. The two-person exercise wheel mechanism of claim 1, wherein:
two rings are fixedly connected in juxtaposition;
two seats are provided between the two rings, so that the two-person exercise wheel is formed; and
a connecting line between respective equivalent positions on the two rings of a same structure is parallel to a concentric axis vertically passing through circular centers of the two rings.

13. The two-person exercise wheel mechanism of claim 2, wherein:
each of the two parallel rings of the two-person exercise wheel is fixedly mounted with a ring at an outward position; and
a diameter of the additional ring is greater than that of the ring of the exercise wheel mechanism.

14. The two-person exercise wheel mechanism of claim 2, wherein:
each of the two rings of the two-person exercise wheel is mounted with the support beams at symmetrical positions; and
the support beams on the two parallel rings maintain consistent positions.

15. The two-person exercise wheel mechanism of claim 2, wherein:
the parallelogram linkage mechanism is a non-equilateral parallelogram linkage mechanism;
when two ends connected to the seats are in upper and lower positions, two connecting rods of the non-equilateral parallelogram linkage mechanism connected at one end where the seat is at a lower end present a long right rod and a short left rod; and
two connecting rods of the non-equilateral parallelogram linkage mechanism connected at the other end where the seat is at an upper end present a short right rod and a long left rod.

16. The two-person exercise wheel mechanism of claim 2, wherein:
the ring is provided with the two stoppers; and
when the ring is rotated clockwise, the rocker arm levers are restricted by the stoppers from rotating clockwise around points of the ring to which the rocker arm levers are hinged as circular centers.

17. The two-person exercise wheel mechanism of claim 2, wherein for springs and spring strength adjustment devices within the range of the two-person exercise wheel, the two springs maintain consistent tensile strength as much as possible.

18. The two-person exercise wheel mechanism of claim 2, wherein when the circular center of the ring is fixedly mounted, the ring is replaceable by a connecting rod passing through the circular center of the ring.

19. The two-person exercise wheel mechanism of claim 2, wherein:
the seat on the two-person exercise wheel is formed by means of connection of suspension racks and a seat plate;
the two suspension racks of each seat are interconnected by a rigid back beam of the seat; and
the seat plate is mounted to the suspension racks of the seat in a suspending manner.

20. The two-person exercise wheel mechanism according to claim 2, wherein:
a pedal is provided on the two-person exercise wheel;
armrest handles are provided on the suspension racks on both sides of the seat;
a safety belt is further provided; and
the armrest handles are provided symmetrically on the sides of the seat.
